(19) United States
(12) Patent Application Publication
(10) Pub. No.: US 2007/0244319 A1
(43) Pub. Date: Oct. 18, 2007

(54) Metallocenyl P-N ligands, preparation thereof, and use for asymmetric catalysis

(76) Inventors: Neil Warren Boaz, Kingsport, TN (US); James Allen Ponasik JR., Blountville, TN (US)

Correspondence Address: Brett L. Nelson;Eastman Chemical Company, P.O. Box 511, Kingsport, TN, 37662-5075, US

(21) Appl. No.: 11/406,095

(22) Filed: Apr. 18, 2006

(51) Int. Cl. C07F 17/00

(52) U.S. Cl. 544/225; 548/101; 546/2

(57) ABSTRACT

Bidentate phosphine-nitrogen ligands are disclosed which include a phosphine linked with a nitrogen heterocycle through a chiral ferrocene backbone. The ligands can include an imidazole or a dihydroimidazole linked to the ferrocene through the 2-position. Ligands can be prepared with or without additional chirality in the heterocycle. The ligands are useful for asymmetric catalysis, such as for palladium-catalyzed asymmetric allylation and ruthenium-catalyzed asymmetric transfer hydrogenation, affording products with high enantioselectivities.

### FIELD OF THE INVENTION

This invention relates to bidentate phosphine-nitrogen ligands which are useful for asymmetric catalysis. The ligands can be used to produce products with high enantioselectivities.

### BACKGROUND OF THE INVENTION

Asymmetric catalysis is the most efficient method for the generation of products with high enantiomeric purity, as the asymmetry of the catalyst is multiplied many times over in the generation of the chiral product. These chiral products have found numerous applications as building blocks for single enantiomer pharmaceuticals as well as in some agrochemicals. The asymmetric catalysts employed can be enzymatic or synthetic in nature. The latter types of catalyst have much greater promise than the former due to much greater latitude of applicable reaction types. Synthetic asymmetric catalysts are usually composed of a metal reaction center surrounded by one or more organic ligands. The ligands usually are generated in high enantiomeric purity, and are the agents inducing the asymmetry.

Ligands based on a ferrocene backbone have found wide application for asymmetric catalysis. Ferrocenyloxazoline phosphorus-nitrogen ligands have found numerous applications for asymmetric catalysis, particularly for asymmetric transfer hydrogenation (Sammakia, T.; Strangeland, E. L. J. Org. Chem. 1997, 62, 6104-6105; Nishbayashi, Y.; Takei, I.; Uemura, S.; Hidai, M. Organometallics 1999, 18, 2291-2293), asymmetric allylation (Koch, G.; Pfaltz, A. Tetrahedron:Asymmetry 1996, 7, 2213-2216; Ahn, K. H.; Cho, C.-W.; Park, J.; Lee, S. Tetrahedron:Asymmetry 1997, 8, 1179-1185), and asymmetric hydrosilylation (Nishibayashi, Y.; Segawa, K.; Ohe, K.; Uemura, S. Organometallics 1995, 14, 5486-5487; Nishibayashi, Y.; Takei, I.; Uemura, S.; Hidai, M. Organometallics 1998, 17, 3420-3422; Takei, I.; Nishibayashi, Y.; Arikawa, Y.; Uemura, W.; Hidai, M. Organometallics 1999, 18, 2271-2274). All of these species possess both axial (ferrocene) chirality and central chirality on the oxazoline ring. There have been several descriptions of PN ligands based on dinitrogen hetereocycles. These species are all imidazolino-phosphines based on a benzene backbone, with chirality center(s) on the imidazoline ring (Busacca, C. A.; U.S. Pat. No. 6,316,620, 2001; Busacca, C. A.; Grossbach, D.; So, R. C.; O'Brien, E. M.; Spinelli, E. M. Org. Lett. 2003, 5, 595-598; Menges, F.; Neuberg, M.; Pfaltz, A. Org. Lett. 2002, 4, 4713-4716; Kim, G.-J.; Kim, S.-H.; Chong, P.-H.; Kwon, M.-A. Tetrahedron Lett. 2002, 43, 8059-8062; Guiu, E.; Claver, C.; Benet-Buchholz, J.; Castillon, S. Tetrahedron:Asymmetry 2004, 15, 3365-3373). These species are generally prepared from the corresponding hydroxy-amide and an amine (Boland, N. A.; Casey, M.; Hynes, S. J.; Matthews, J. W.; Smyth, M. P. J. Org. Chem. 2002, 67, 3919-3922), an imidate ester and a diamine (Kim et al, above) or the corresponding dithioester and a diamine (Guiu et al, above). These species have found utility for Palladium-catalyzed asymmetric Heck reactions and Iridium-catalyzed asymmetric hydrogenations.

### SUMMARY OF THE INVENTION

An embodiment of the present invention concerns a new class of metallocenyl PN ligands of structure 1 and 2 (the enantiomer of 1): 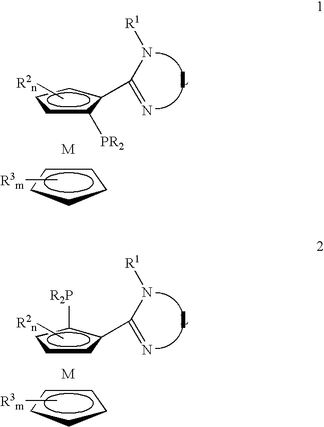
wherein

R, R²and R³ are selected from hydrogen, substituted and unsubstituted, branched- and straight-chain C₂-C₂₀ alkyl, substituted and unsubstituted C₃-C₈ cycloalkyl, substituted and unsubstituted C₆-C₂₀ carbocyclic aryl, and substituted and unsubstituted C₄-C₂₀ heteroaryl wherein the heteroatoms are selected from sulfur, nitrogen, and oxygen;

R¹ is selected from hydrogen, substituted and unsubstituted, branched- and straight-chain C₁-C₂₀ alkyl, substituted and unsubstituted C₃-C₈ cycloalkyl, substituted and unsubstituted C₁-C₂₀ acyl, substituted and unsubstituted C₁-C₂₀ sulfonyl, substituted and unsubstituted C₆-C₂₀ carbocyclic aryl, and substituted and unsubstituted C₄-C₂₀ heteroaryl wherein the heteroatoms are selected from sulfur, nitrogen, and oxygen;

L is a divalent radical linking the two nitrogens which may or may not possess substantially enantiomerically pure chiral centers;

n is 0 to 3;

m is 0 to 5; and

M is selected from the metals of Groups IVB, VB, VIB, VIIB and VIII.

Another embodiment of the present invention concerns a process for the preparation of the metallocenyl P—N ligands of structure 1: 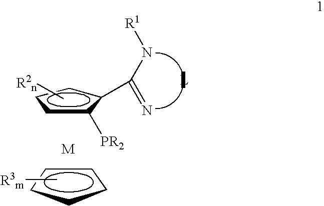
which comprises:
(1) reacting, or contacting, oxazoline 3: 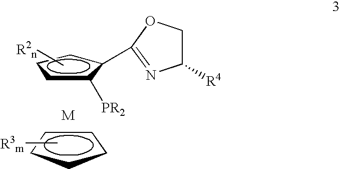
   with a diamine H₂N-L-NHR¹ in an inert solvent in the presence of an acid wherein R⁴ is chosen from substituted and unsubstituted, branched- and straight-chain C₁-C₂₀ alkyl, substituted and unsubstituted C₃-C₈ cycloalkyl, and substituted and unsubstituted C₆-C₂₀ carbocyclic aryl.

In yet another embodiment of the present invention, the other enantiomer of the PN ligands (2) can be prepared in a similar fashion starting from phosphine-oxazoline compound 4.

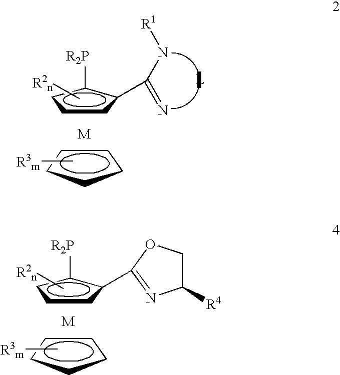

Yet another embodiment of the present invention concerns a process for the reduction of a reducible compound which comprises contacting the reducible compound with hydrogen or a hydrogen transfer agent in the presence of a catalyst complex comprising ligand 1 or 2 in complex association with a metal.

Another embodiment concerns a process for the asymmetric allylation of a suitable allylic compound which comprises contacting an allylic electrophile compound with a nucleophile in the presence of a catalyst complex comprising ligands 1 or 2 in complex association with a metal.

### DETAILED DESCRIPTION OF THE INVENTION

The present invention concerns bidentate phosphine-nitrogen ligands which include a phosphine linked with a nitrogen heterocycle through a chiral ferrocene backbone. The ligands can include an imidazole or a dihydroimidazole linked to the ferrocene through the 2-position, and can be prepared with or without additional chirality in the heterocycle. The ligands are useful for asymmetric catalysis (for example, for palladium-catalyzed asymmetric allylation and ruthenium-catalyzed asymmetric transfer hydrogenation) affording products with high enantioselectivities.

The present invention concerns a new class of metallocenyl PN ligands of structure 1 and 2 (the enantiomer of 1): 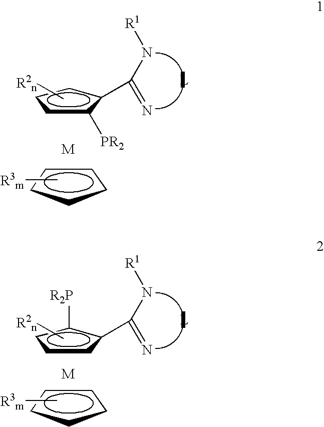
wherein

R, R²and R³ are selected from hydrogen, substituted and unsubstituted, branched- and straight-chain C₁-C₂₀ alkyl, substituted and unsubstituted C₃-C₈ cycloalkyl, substituted and unsubstituted C₆-C₂₀ carbocyclic aryl, and substituted and unsubstituted C₄-C₂₀ heteroaryl wherein the heteroatoms are selected from sulfur, nitrogen, and oxygen;

R¹ is selected from hydrogen, substituted and unsubstituted, branched- and straight-chain C₂-C₂₀ alkyl, , substituted and unsubstituted C₃-C₈ cycloalkyl, substituted and unsubstituted C₁-C₂₀ acyl, substituted and unsubstituted C₁-C₂₀ sulfonyl, substituted and unsubstituted C₆-C₂₀ carbocyclic aryl, and substituted and unsubstituted C₄-C₂₀ heteroaryl wherein the heteroatoms are selected from sulfur, nitrogen, and oxygen;

L is a divalent radical linking the two nitrogens which may or may not possess substantially enantiomerically pure chiral centers;

n is 0 to 3;

m is 0 to 5; and

M is selected from the metals of Groups IVB, VB, VIB, VIIB and VIII.

The alkyl groups, which may be represented by each of R, R¹, R², and R³, may be straight- or branched-chain aliphatic hydrocarbon radicals containing up to about 20 carbon atoms and may be substituted, for example, with one to three groups selected from C₁-C₆-alkoxy, cyano, C₂-C₆-alkoxycarbonyl, C₂-C₆-alkanoyloxy, hydroxy, aryl and halogen. The terms “Cₗ-C₆-alkoxy”, “C₂-C₆-alkoxycarbonyl”, and “C₂-C₆-alkanoyloxy” are used to denote radicals corresponding to the structures —OR⁷—CO₂ R⁷, and —OCOR⁷, respectively, wherein R⁷ is C₁-C₆-alkyl or substituted C₁-C₆-alkyl. The term “C₃-C₈-cycloalkyl” is used to denote a saturated, carbocyclic hydrocarbon radical having three to eight carbon atoms. The aryl groups, which may represent each of R, R¹, R², and R³, may include phenyl, naphthyl, or anthracenyl and phenyl, naphthyl, or anthracenyl substituted with one to three substituents selected from C₁-C₆-alkyl, substituted C₁-C₆-alkyl, C₆-C₁₀ aryl, substituted C₆-C₁₀ aryl, C₁-C₆-alkoxy, halogen, carboxy, cyano, C₁-C₆-alkanoyloxy, C₁-C₆-alkylthio, C₁-C₆-alkylsulfonyl, trifluoromethyl, hydroxy, C₂-C₆-alkoxycarbonyl, C₂-C₆-alkanoylamino and —O—R⁸, S—R⁸, —SO₂—R⁸, —NHSO₂R⁸ and —NHCO₂R⁸, wherein R⁸ is phenyl, naphthyl, or phenyl or naphthly substituted with one to three groups selected from C₁-C₆-alkyl, C₆-C₁₀ aryl, C₁₋C₆-alkoxy and halogen. The heteroaryl radicals, which may represent each of R, R¹, R², and R³, may include a 5- or 6-membered aromatic ring containing one to three heteroatoms selected from oxygen, sulfur and nitrogen. Examples of such heteroaryl groups are thienyl, furyl, pyrrolyl, imidazolyl, pyrazolyl, thiazolyl, isothiazolyl, oxazolyl, isoxazolyl, triazolyl, thiadiazolyl, oxadiazolyl, tetrazolyl, pyridyl, pyrimidyl, benzoxazolyl, benzothiazolyl, benzimidazolyl, indolyl and the like. The heteroaryl radicals may be substituted, for example, with up to three groups such as C₁-C₆-alkyl, C₁-C₆-alkoxy, substituted C₁-C₆-alkyl, halogen, C₁-C₆-alkylthio, aryl, arylthio, aryloxy, C₂-C₆-alkoxycarbonyl and C₂-C₆-alkanoylamino. The heteroaryl radicals also may be substituted with a fused ring system, e.g., a benzo or naphtho residue, which may be unsubstituted or substituted, for example, with up to three of the groups set forth in the preceding sentence. The term “halogen” is used to include fluorine, chlorine, bromine, and iodine.

The acyl groups, which may be represented by R¹, may be straight- or branched-chain carboxyl radicals containing up to about 20 carbon atoms and may be substituted, for example, with one to three groups selected from C₁-C₆-alkoxy, cyano, C₂-C₆-alkoxycarbonyl, C₂-C₆-alkanoyloxy, hydroxy, aryl and halogen.

The sulfonyl groups, which may be represented by R¹, may be straight- or branched-chain sulfonyl radicals containing up to about 20 carbon atoms and may be substituted, for example, with one to three groups selected from C₁-C₆-alkoxy, cyano, C₂-C₆-alkoxycarbonyl, C₂-C₆-alkanoyloxy, hydroxy, aryl and halogen.

The divalent radical L may be a C₁-C₄ substituted or unsubstituted alkylene radical. The substituents may be arranged such that L is achiral, chiral and racemic, or chiral and substantially enantiomerically pure. Examples of such substituents include 1,2-ethanediyl, 1,3-propanediyl, 1,4-butyldiyl, S,S-1,2-dimethylethanediyl, R,R-1,2-dimethylethanediyl, S,S-1,2-diphenylethanediyl, R,R-1,2-diphenylethanediyl, R,R-1,2-diphenylethanediyl, R,R-1,2-cyclohexyldiyl, S,S-1,2-cyclohexyldiyl, R,S-1,2-cyclohexyldiyl and the like. The divalent radical L may also possess unsaturation in the linkage, to form species such as imidazoles when L is a C₂ linker. This C₂ linkage may also be fused with aromatic or heteroaromatic rings (e.g., benzimidazole). The linkage may also contain heteroatoms in the backbone, resulting in substituted or unsubstitued species such as triazoles, tetrazoles, oxadiazoles, thiadiazoles and the like.

The present invention also concerns a process for the preparation of the metallocenyl P—N ligands of structure 1: 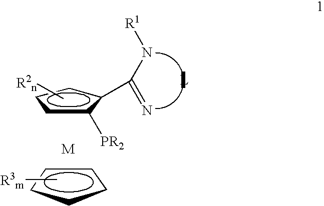
which comprises:
(1) reacting, or contacting, oxazoline 3: 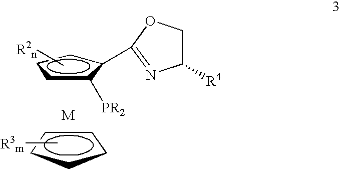
   with a diamine H₂N-L-NHR¹ in an inert solvent in the presence of an acid wherein R⁴ is chosen from substituted and unsubstituted, branched- and straight-chain C₁-C₂₀ alkyl, substituted and unsubstituted C₃-C₈ cycloalkyl, and substituted and unsubstituted C₆-C₂₀ carbocyclic aryl.

The process is carried out in an inert solvent chosen from C₁-C₁₀ alcohols, for example 2-propanol, or polar aprotic solvents, for example acetonitrile. The process may be carried out at a temperature between about 25° C. and the boiling point of the solvent, for example between about 40-120° C. This step is carried out in the presence of an acid chosen from mineral acids, sulfonic acids, or lanthanide ions, for example hydrochloric acid, methanesulfonic acid, or lanthanium(III) trifluoromethanesulfonate. The amount of acid is between 0.1 and 10 equivalents based on the oxazoline 3, for example between 0.5 and 2 equivalents. The amount of diamine is between 1 and 20 equivalents based on oxazoline 3, for example between 2.5 and 10 equivalents.

Isolation of the desired product 1 from the reaction mixture is performed using methods known to those of skill in the art, e.g., extraction, filtration, or crystallization. The product 1 may be purified if necessary using methods known to those of skill in the art, e.g., extraction, chromatography, or crystallization.

The preparative method of the present invention is advantaged over other known methods for several reasons. First, the preparation of many oxazoline starting materials in high enantiomeric and diastereomeric purity is well-known to those in the art (Sammakia, T.; Strangeland, E. L. J. Org. Chem. 1997, 62, 6104-6105; Richards, C. J.; Damalidis, T.; Hibbs, D. E.; Hursthouse, M. B. Synlett 1995, 74-76; Nishibayashi, Y.; Uemura, S.; Synlett 1995, 79-81; Richards, C. J.; Mulvaney, A. W. Tetrahedron:Asymmetry 1996, 7, 1419-1430; Ahn, K. H.; Cho, C.-W.; Baek, H.-H.; Park, J.; Lee, S. J. Org. Chem. 1996, 61, 4937-4943). The utilization of a common substantially pure oxazoline starting material avoids the necessity of finding conditions to diastereoselectively attach the phosphine to the ferrocene ring for each desired target. In addition, this allows the generation of the PN ligands possessing only axial chirality with no chiral centers on the hetereocyclic ring. These materials would otherwise be very challenging to prepare, as there would be no pendant chirality to direct the lithiation and phosphination on the ferrocene ring in an enantioselective manner.

The other enantiomer of the PN ligands (2) can be prepared in a similar fashion starting from phosphine-oxazoline compound 4.

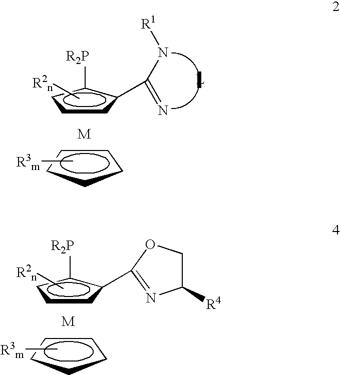

To use the PN ligands 1 and 2, the ligands can be complexed with a catalytically active metal (“metal”). The particular metal chosen depends on the desired reaction. There are a large number of possible reactions of a wide variety of substrates using catalysts based on compound 1 or 2, including but not limited to asymmetric hydrogenations, asymmetric reductions, asymmetric hydroborations, asymmetric olefin isomerizations, asymmetric hydrosilations, asymmetric allylations, asymmetric conjugate additions, and asymmetric organometallic additions. The utility of ligands 1 and 2 will be demonstrated through asymmetric reduction and asymmetric allylation reactions of their metal complexes, which are also embodiments of the present invention. Thus, the present invention includes a process for the reduction of a reducible compound which comprises contacting the reducible compound with a hydrogen transfer agent in the presence of a catalyst complex comprising ligand 1 or 2 in complex association with a metal. Although not wishing to be bound to a particular substrate type, the asymmetric hydrogenation of ketone substrates to afford chiral alcohols is of particular interest in the pharmaceutical industry, and catalysts based on ligands 1 and 2 show particularly high enantioselectivity for these transformations.

A ketone reactant useful in the present invention has the general formula 5, 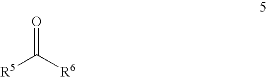
wherein R⁵ and R⁶ are independently selected from hydrogen, substituted and unsubstituted, branched- and straight-chain C₁ to C₂₀ alkyl, substituted and unsubstituted C₃ to C₈ cycloalkyl, substituted and unsubstituted C₆ to C₂₀ carbocyclic aryl, substituted and unsubstituted metallocenyl, and substituted and unsubstituted C₄ to C₂₀ heteroaryl wherein the heteroatoms are selected from sulfur, nitrogen, or oxygen.

The products of the hydrogenation of ketones having formula 5 with catalysts based on ligands 1 or 2 are comprised of species with formula 6, 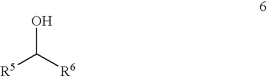
wherein R⁵ and R⁶ are as defined above. These compounds where R⁵ and R⁶ are neither identical nor hydrogen are generally produced with high enantioselectivity (>80% ee), with the particular enantiomer produced depending upon which enantiomer of ligand is used.

For an asymmetric reduction reaction, the metal complexed can be chosen from the group consisting of rhodium, ruthenium, or iridium. The ligand-metal complex can be prepared and isolated, but the complex can also be prepared in situ from ligand 1 or 2 and a metal pre-catalyst such as dichlorotris(triphenylphosphine)ruthenium by simply mixing the two components in the desired solvent at a temperature at which the complex will form, generally between 25° C. and the boiling point of the solvent, for example between 25 and 100° C. The ligand to metal molar ratio may be in the range of about 0.5:1 to 5:1, for example about 1:1 to 3:1. The amount of complex may vary between 0.00005 and 0.5 equivalents based on the reactant compound, with more complex usually providing faster reaction rates. The atmosphere may be inert to the reaction conditions, although these reactions can often be performed under a moderate pressure of hydrogen, for example between 0.68 and 6.8 barg. The use of a hydrogen atmosphere allows the reaction to be run at high concentration without loss of conversion or enantioselectivity, a feature that is not usually observed in these reactions. The reaction is run at a temperature which affords a reasonable rate of conversion, which can be as low as −50° C. but can also be between ambient temperature and the boiling point (or apparent boiling point at elevated pressure) of the lowest boiling component of the reaction mixture. The reaction employs a hydrogen donor, which is generally chosen from alcohols, formate salts, or phosphinic acid salts. For example, an alcohol, such as isopropanol, can be used as a donor and also perform as the reaction solvent. The reaction is usually run in the presence of a solvent chosen from aliphatic alcohols such as methanol, ethanol, n-propanol, 2-propanol, n-butanol, 2-butanol, tert-butanol and the like, aliphatic hydrocarbons such as hexane, heptane, octane and the like, aromatic hydrocarbons such as toluene, xylenes, and the like, cyclic or acyclic ethers such as tert-butyl methyl ether, diisopropyl ether, tetrahydrofuran and the like, halogenated aliphatic or aromatic hydrocarbons such as dichloromethane, tetrachloroethylene, chloroform, chlorobenzene and the like, or polar aprotic solvents such as dimethylformamide, dimethyl sulfoxide and the like. An adequate example of the solvent is 2-propanol. The reaction is also run in the presence of a Bronsted base chosen from alkali metal hydroxides, alkali metal alkoxides, alkaline earth metal hydroxides, alkaline earth metal alkoxides, tetralkylammonium hydroxides, and tetralkylammonium alkoxides. Potassium hydroxide, potassium isopropoxide, and potassium tert-butoxide are adequate bases.

The present invention also includes a process for the asymmetric allylation of a suitable allylic compound which comprises contacting the allylic electrophile compound with a nucleophile in the presence of a catalyst complex comprising ligands 1 or 2 in complex association with a metal.

An allylic electrophile reactant useful in such a method has the general formula 7, 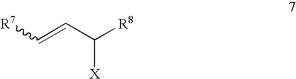
wherein R⁷ and R⁸ are independently selected from hydrogen, substituted and unsubstituted, branched- and straight-chain C₁ to C₂₀ alkyl, substituted and unsubstituted C₃ to C₈ cycloalkyl, substituted and unsubstituted C₆ to C₂₀ carbocyclic aryl, and substituted and unsubstituted C₄ to C₂₀ heteroaryl wherein the heteroatoms are selected from sulfur, nitrogen, or oxygen; or

R⁷ and R⁸ collectively represent a substituted or unsubstituted alkylene group of 0-5 chain carbon atoms; and

X is chosen from chloride, bromide, iodide, sulfonates of formula —OSO2R⁹, esters of formula —OCOR⁹, and carbonates of formula —OCOOR⁹, wherein R⁹ is selected from hydrogen, substituted and unsubstituted, branched- and straight-chain C₁ to C₂₀ alkyl, substituted and unsubstituted C₃ to C₈ cycloalkyl, substituted and unsubstituted C₆ to C₂₀ carbocyclic aryl, and substituted and unsubstituted C₄ to C₂₀ heteroaryl wherein the heteroatoms are selected from sulfur, nitrogen, or oxygen.

The nucleophiles mentioned above (that are reacted with allylic electrophiles) are of the form Nu-H. These nucleophiles include species such as soft carbon acids such as malonates, 3-ketoesters, 2-cyanoesters, and the like, substituted or unsubstituted C₁-C₂₀ alcohols, substituted or unsubstituted phenols, and substituted or unsubstituted C₁-C₂₀ amines.

The products of the allylation reactions of the allylic electrophiles having formula 10 with catalysts based on ligands 1 and 2 are comprised of species with formula 8 or 9, 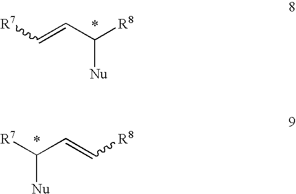
wherein R⁷and R⁸ are as defined above. These compounds are generally produced with high enantioselectivity (>80% ee), with the particular enantiomer produced depending upon whether ligand 1 or ligand 2 is used.

For an asymmetric allylation reaction, the metal complexed can be chosen from the group consisting of palladium, platinum, or molybdenum. The ligand-metal complex can be prepared and isolated, but the complex can also be prepared in situ from ligand 1 or 2 and a metal pre-catalyst such as allylpalladium chloride dimer by simply mixing the two components in the desired solvent. The ligand to metal molar ratio may be in the range of about 0.5:1 to 5:1, for example about 1:1 to 1.5:1. The amount of complex may vary between 0.00005 and 0.5 equivalents based on the reactant compound, with more complex usually providing faster reaction rates. The atmosphere is generally inert to the allylation reaction conditions. The allylation reaction can be run at atmospheric pressure or at slightly elevated pressure. The reaction is run at a temperature which affords a reasonable rate of conversion, which can be as low as −50° C. but can also be between ambient temperature and the boiling point (or apparent boiling point at elevated pressure) of the lowest boiling component of the reaction mixture. The reaction is often run in the presence of a solvent chosen from aliphatic hydrocarbons such as hexane, heptane, octane and the like, aromatic hydrocarbons such as toluene, xylenes, and the like, cyclic or acyclic ethers such as tert-butyl methyl ether, diisopropyl ether, tetrahydrofuran and the like, halogenated aliphatic or aromatic hydrocarbons such as dichloromethane, tetrachloroethylene, chloroform, chlorobenzene and the like, or polar aprotic solvents such as dimethylformamide, dimethyl sulfoxide and the like. The reactions are optionally run in the presence of a proton acceptor such as an alkali salt of a carboxylic acid, an alkali carbonate, or an amine. The reactions are also often run in the presence of an acid scavenger such as N,O-bis(trimethylsilyl)trifluoroacetamide.

The following examples are illustrative purposes and are in no way meant to represent the entire scope of the present invention.

### EXAMPLE 1

### Preparation of 2-[(S)-2-(diphenylphosphino)ferrocenyl]-4,5-dihydro-1H-imidazole (1a)

(S)-2-[(S)-2-(diphenylphosphino)ferrocenyl]-4-(1-methylethyl)oxazoline (3a)(700 mg; 1.45 mmol) was combined with 20 mL of isopropanol. 1,2-Diaminoethane (874 mg; 14.5 mmol; 10 equiv) was added followed by methanesulfonic acid (280 mg; 1.91 mmol; 2.0 equiv). The reaction mixture was purged with argon for 10 min and then heated to reflux for 36 h to nearly completely consume 3a according to tlc analysis. The reaction mixture was cooled to ambient temperature, diluted with 50 mL of water and 5 mL of 4 M NaOH, and extracted three times with ethyl acetate. The combined extracts were washed with 10 mL of brine, dried (MgSO₄) and concentrated to afford 0.83 g of crude product. This material was filtered through a pad of flash silica gel and eluted with ethyl acetate (impurities), then isopropanol, then 5% triethylamine in isopropanol. This afforded 493 mg (77%) of pure 1a along with 117 mg (18%) of 1a contaminated with a little phosphine oxide.

¹H NMR (CDCl₃) δ 7.59-7.53 (m, 2H); 7.44-7.40 (m, 3H); 7.26-7.24 (m, 3H); 7.14-7.08 (m, 2H); 5.325 (br s, 1H); 4.50 (m, 1H); 4.111 (s, 5H); 3.84 (m, 1H); 3.67-3.61 (m, 4H). ESIMS: m/z 439 (MH⁺).

### EXAMPLE 2

### Preparation of 2-[(S)-2-(diphenylphosphino)ferrocenyl]-4,5-dihydro-1H-imidazole (1a) using lanthanium(III) trifluoromethanesulfonate

(S)-2-[(S)-2-(diphenylphosphino)ferrocenyl]-4-(1-methylethyl)oxazoline (3a)(1.00 mg; 2.08 mmol) and lanthanium(III) trifluoromethanesulfonate (609 mg; 1.04 mmol; 0.50 equiv) were combined with 40 mL of acetonitrile. 1,2-Diaminoethane (1.25 g; 20 mmol; 10 equiv) was added. The reaction mixture was purged with argon for 15 min and then heated to reflux under argon for 18 h to nearly completely consume 3a according to tlc analysis. The reaction mixture was cooled to ambient temperature, diluted with 70 mL of water and 10 mL of 4 M NaOH, and extracted three times with ethyl acetate. The combined extracts were washed with 10 mL of brine, dried (MgSO₄) and concentrated to afford 1.37 g of crude product. This material was filtered through a pad of flash silica gel and eluted with ethyl acetate (impurities), then with 1:3 isopropanol:ethyl acetate to afford 877 mg (96%) of 1a contaminated with a little phosphine oxide.

### EXAMPLE 3

### Preparation of [4(S),5(S])-2-[(S)-2-(diphenylphosphino)ferrocenyl]-4,5-diphenyl-4,5-dihydro-1H-imidazole (1b)

(S)-2-[(S)-2-(diphenylphosphino)ferrocenyl]-4-(1-methylethyl)oxazoline (3a)(250 mg; 0.52 mmol) was combined with [1(S),2(S)]-1,2-diphenylethylenediamine (551 mg; 2.56 mmol; 5 equiv) and 7 mL of isopropanol was added. Methanesulfonic acid (75 mg; 0.78 mmol; 1.5 equiv) was added, and the flask was evacuated and filled with nitrogen ten times. The reaction mixture was heated to reflux for 40 h to nearly completely consume 3a according to tlc analysis. The reaction mixture was cooled to ambient temperature, diluted with 10 mL of water and 1 mL of 4 M NaOH, and extracted twice with ethyl acetate. The combined extracts were washed with 10 mL of brine, dried (MgSO₄) and concentrated to afford 0.87 g of crude product. This material was filtered through a pad of flash silica gel and eluted with 1:1 ethyl acetate:heptane (impurities), then 1:1 ethyl acetate:heptane with 5% triethylamine to afford 257 mg (84%) of lb.

¹H NMR (CDCl₃) δ 7.6-7.0 (m, 20H); 5.5-5.4 (br s, 1H); 4.8-4.7 (br s, 3H); 4.556 (br s, 1H); 4.242 (s, 5H); 3.880 (br s, 1H).

### EXAMPLE 4

### Preparation of [4(R),5(R)]-2-[(S)-2-(diphenylphosphino)ferrocenyl]-4,5-diphenyl-4,5-dihydro-1H-imidazole (1c)

(S)-2-[(S)-2-(diphenylphosphino)ferrocenyl]-4-(1-methylethyl)oxazoline (3a)(250 mg; 0.52 mmol) was combined with [1(R),2(R)]-1,2-diphenylethylenediamine (551 mg; 2.56 mmol; 5 equiv) and 7 mL of isopropanol was added. Methanesulfonic acid (75 mg; 0.78 mmol; 1.5 equiv) was added, and the flask was evacuated and filled with nitrogen ten times. The reaction mixture was heated to reflux for 30 h to nearly completely consume 3a according to tlc analysis. The reaction mixture was cooled to ambient temperature, diluted with 10 mL of water and 1 mL of 4 M NaOH, and extracted twice with ethyl acetate. The combined extracts were washed with 10 mL of brine, dried (MgSO₄) and concentrated to afford 0.89 g of crude product. This material was filtered through a pad of flash silica gel and eluted with 1:4 ethyl acetate:heptane (impurities), then 1:2 ethyl acetate:heptane with 5% triethylamine to afford 303 mg (99%) of 1c.

¹H NMR (CDCl₃) δ 7.6-7.1 (m, 20H); 5.0 (br s, 1H); 4.81 (br s, 3H); 4.603 (br s, 1H); 4.256 (s, 5H); 3.879 (br s, 1H).

### EXAMPLE 5

### Preparation of N-Acetyl 2-[(S)-2-(diphenylphosphino)ferrocenyl]-4,5-dihydro-1H-imidazole (1d)

Dihydroimidazole 1a (200 mg; 0.46 mmol) was dissolved in 5 mL of dry dichloromethane. The reaction mixture was cooled in ice-water and purged with argon for 5 min. Triethylamine (95 uL; 0.68 mmol; 1.5 equiv) was added followed by acetic anhydride (49 uL; 0.50 mmol; 1.1 equiv). The reaction mixture was allowed to warm to ambient temperature over 2 h to consume almost all 1a by tlc. The mixture was stirred an additional 2.5 h at ambient temperature, then diluted with ethyl acetate and water. The layers were separated and the aqueous layer was extracted once more with ethyl acetate. The combined organic solution was washed with brine (10 mL), dried (MgSO₄), and concentrated to afford 0.19 g of crude product. This material was filtered through a pad of flash silica gel and eluted with 1:1 ethyl acetate:heptane to afford 171 mg (78%) of 1d.

¹H NMR (CDCl₃) δ 7.7-7.3 (m, 10H); 4.664 (br s, 1H); 4.45 (br s, 1H); 4.39 (br s, 1H); 4.235 (s, 5H) 4.05-3.9 (m, 2H); 3.8-3.65 (m, 3H); 1.665 (s, 3H).

### EXAMPLE 6

### Asymmetric Transfer Hydrogenation of Acetophenone Using a Ruthenium Complex of Ligand 1a Under Hydrogen

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. Acetophenone (5a) (120 mg; 1.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.005 mmol; 0.005 equiv) was added to afford a pale red solution, the vessel was evacuated and filled with argon five times, and the mixture was stirred for 5 min. A 1.0 M solution of potassium tert-butoxide in tert-butanol (50 uL; 0.05 mmol; 0.05 equiv) was added, which turned the reaction mixture orange. The vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The vessel was then evacuated and filled with argon five times. Analysis by chiral GC indicated 90.7% conversion and 92.0% ee for (S)-1-phenylethanol (S-6a). All physical properties for 6a were identical to an authentic sample.

Chiral GC [Cyclosil-B (J&W Scientific), 40° C. to 100° C. at 70° C./min, hold at 100° C. for 15 minutes, 100° C. to 170° C. at 15° C./min, hold at 170° C. for 7 min]: t_{R}=13.5 min (5a), t_{R}=18.7 min (R-6a), t_{R}=18.9 min (S-6a).

### COMPARATIVE EXAMPLE 1

### Asymmetric Transfer Hydrogenation of Acetophenone Using a Ruthenium Complex of Ligand 1Under Argon

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. Acetophenone (5a) (120 mg; 1.0 mmol) was added to a flask, the flask was evacuated and filled with nitrogen ten times, and 3.0 mL of argon-degassed isopropanol was added. 1.0 mL of the solution of the ruthenium complex of 1a (0.00125 mmol; 0.005 equiv) was added to afford a pale red solution, the flask was evacuated with nitrogen five times, and the solution was stirred for 5 min. A 1.0 M solution of potassium tert-butoxide in tert-butanol (50 uL; 0.05 mmol; 0.05 equiv) was added, which turned the reaction mixture orange. The vessel was evacuated and filled with nitrogen ten times, then stirred under nitrogen for 2 h, at which time chiral GC analysis indicated 90.3% conversion and 73.4% ee for (S)-1-phenylethanol (S-6a).

### EXAMPLE 7

### Asymmetric Transfer Hydrogenation of Acetophenone at 1.0 M Concentration Using a Ruthenium Complex of Ligand 1a Under Hydrogen

Dichlorotris(triphenylphosphine)ruthenium(II) (7.7 mg; 0.008 mmol) and ligand 1a (8.4 mg; 0.019 mmol; 2.4 equiv based on Ru) were combined in a flask and purged with argon for 15 min. Argon-degassed isopropanol (2.0 mL) was added and the mixture was heated to reflux for 30 min and then cooled to ambient temperature to afford a rose-red solution of the ruthenium complex of 1a. Acetophenone (5a) (481 mg; 4.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.004 mmol; 0.001 equiv) was added to afford a pale red solution, the vessel was evacuated and filled with argon five times, and the mixture was stirred for 5 min. A 1.0 M solution of potassium tert-butoxide in tert-butanol (60 uL; 0.06 mmol; 0.015 equiv) was added, which turned the reaction mixture orange. The vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The reaction mixture was periodically sampled and analyzed by chiral GC. After 46 h chiral GC indicated 99.3% conversion and 91.3% ee for (S)-1-phenylethanol (S-6a).

### COMPARATIVE EXAMPLE 2

### Asymmetric Transfer Hydrogenation of Acetophenone at 1.0 M Concentration Using a Ruthenium Complex of Ligand 1a Under Argon

Dichlorotris(triphenylphosphine)ruthenium(II) (7.7 mg; 0.008 mmol) and ligand 1a (8.4 mg; 0.019 mmol; 2.4 equiv based on Ru) were combined in a flask and purged with argon for 15 min. Argon-degassed isopropanol (2.0 mL) was added and the mixture was heated to reflux for 30 min and then cooled to ambient temperature to afford a rose-red solution of the ruthenium complex of 1a. Acetophenone (5a) (241 mg; 2.0 mmol) was added to a pressure vessel, a pressure head was attached, and the vessel was evacuated and filled with argon ten times. Argon-degassed isopropanol (1.5 mL) was added and the vessel was evacuated and filled with argon five times. 0.5 mL of the solution of the ruthenium complex of 1a (0.002 mmol; 0.001 equiv) was added to afford a pale red solution, the vessel was evacuated and filled with argon five times, and the mixture was stirred for 5 min. A 1.0 M solution of potassium tert-butoxide in tert-butanol (30 uL; 0.03 mmol; 0.015 equiv) was added, which turned the reaction mixture orange. The vessel was evacuated and filled with argon ten times, then placed under an argon atmosphere. The reaction mixture was periodically sampled and analyzed by chiral GC. After 44 h chiral GC indicated 51.6% conversion and 86.2% ee for (S)-1-phenylethanol (S-6a).

### EXAMPLE 8

### Asymmetric Transfer Hydrogenation of a Cetophenone Using a Ruthenium Complex of Ligand 1b Under Argon

Dichlorotris(triphenylphosphine)ruthenium(II) (9.6 mg; 0.010 mmol; 0.005 equiv) and ligand 1b (7.1 mg; 0.012 mmol; 1.2 equiv based on Ru) were combined in a flask and evacuated and filled with nitrogen ten times. Argon-degassed isopropanol (8.0 mL) was added and the mixture was heated to reflux for 30 min and then cooled to ambient temperature to afford a brown solution of the ruthenium complex of 1b. Acetophenone (5a) (240 mg; 2.0 mmol) was added to the solution of the complex and the mixture was stirred for 5 min. A 1.0 M solution of potassium hydroxide in methanol (100 uL; 0.10 mmol; 0.05 equiv) was added, which turned the reaction mixture orange. The mixture was stirred under nitrogen for 6 h, at which time chiral GC analysis indicated 23.7% conversion and 64.4% ee for (R)-1-phenylethanol (R-6a).

### EXAMPLE 9

### Asymmetric Transfer Hydrogenation of Acetophenone Using a Ruthenium Complex of Ligand 1d Under Argon

Dichlorotris(triphenylphosphine)ruthenium(II) (4.8 mg; 0.005 mmol; 0.005 equiv) and ligand 1d (3.1 mg; 0.0065 mmol; 1.3 equiv based on Ru) were combined in a flask and evacuated and filled with nitrogen ten times. Argon-degassed isopropanol (2.0 mL) was added and the mixture was heated to reflux for 30 min and then cooled to ambient temperature to afford an orange-red solution of the ruthenium complex of 1d. Acetophenone (5a) (120 mg; 1.0 mmol) in 2.0 mL of argon-degassed ipa was added to the solution of the complex and the mixture was stirred for 5 min. A 1.0 M solution of potassium tert-butoxide in tert-butanol (50 uL; 0.05 mmol; 0.05 equiv) was added, which turned the reaction mixture orange. The mixture was stirred under nitrogen for 4.5 h, at which time chiral GC analysis indicated 67.7% conversion and 56.6% ee for (S)-1-phenylethanol (S-6a).

### EXAMPLE 10

### Asymmetric Transfer Hydrogenation of Acetylferrocene Using a Ruthenium Complex of Ligand 1a Under Hydrogen

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. Acetylferrocene (5b) (228 mg; 1.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.005 mmol; 0.005 equiv) was added, the vessel was evacuated and filled with argon five times, and the mixture was stirred for 5 min. A 1.0 M solution of potassium tert-butoxide in tert-butanol (50 uL; 0.05 mmol; 0.05 equiv) was added, and the vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The vessel was sampled and analyzed by chiral HPLC to indicate 24.1% conversion and 96.4% ee for (S)-1-ferrocenylethanol (S-6b).

Chiral HPLC [250×4.6 mm Chiralpak AS (Chiral Technologies), 90:10 hexane:isopropanol, 1 mL/min, 254 nm]: t_{R}=7.1 min (S-6b), t_{R}=11.4 min (R-6b), t_{R}=31.2 min (5b).

### EXAMPLE 11

### Asymmetric Transfer Hydrogenation of 2-Acetonaphthone Using a Ruthenium Complex of Ligand 1a Under Hydrogen

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. 2-Acetonaphthone (5c) (170 mg; 1.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.005 mmol; 0.005 equiv) was added, the vessel was evacuated and filled with argon five times, and the mixture was stirred for 5 min. A 1.0 M solution of potassium tert-butoxide in tert-butanol (50 uL; 0.05 mmol; 0.05 equiv) was added affording an immediate color change from pale red to orange, and the vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The vessel was sampled and analyzed by chiral GC and HPLC to indicate 90.6% conversion and 92.8% ee for (S)-1-(2-naphthyl)ethanol (S-6c). The reaction was stopped after 4 h by evacuating and filling with argon five times and the solution was stripped to afford 164 mg, which analyzed at 92.1% conversion, 91.8% ee S-6c.

¹H NMR (CDCl₃) δ 7.84-7.81 (m, 4H); 7.51-7.46 (m, 3H); 5.067 (q, 1H, J=6.32 Hz); 1.579 (d, 3H, J=6.32 Hz). Chiral GC [Cyclosil-B (J&W Scientific), 165° C., hold for 15 min, 165 to 200° C. at 15° C./min, hold at 200° C. for 15 minutes]: t_{R}=20.5 min (5d), t_{R}=22.7 min (R-6d), t_{R}=22.8 min (S-6d).

### EXAMPLE 12

### Asymmetric Transfer Hydrogenation of 4-Chloroacetophenone Using a Ruthenium Complex of Ligand 1a Under Hydrogen

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. 4-Chloroacetophenone (5d) (155 mg; 1.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.005 mmol; 0.005 equiv) was added, the vessel was evacuated and filled with argon five times, and the mixture was stirred for 5 min. A 1.0 M solution of potassium tert-butoxide in tert-butanol (50 uL; 0.05 mmol; 0.05 equiv) was added affording an immediate color change from pale red to orange, and the vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The vessel was sampled and analyzed by chiral GC to indicate 94.1% conversion and 92.4% ee for (S)-1-(4-chlorophenyl)ethanol (S-6d). The reaction was stopped after 5 h by evacuating and filling with argon five times and the solution was stripped to afford 156 mg, which analyzed at 95.8% conversion, 91.4% ee S-6d.

¹H NMR (CDCl₃) δ 7.307 (s, 4H); 4.881 (q, 1H, J=6.32 Hz); 1.472 (d, 3H, J=6.32 Hz). Chiral GC [Cyclosil-B (J&W Scientific), 40° C. to 100° C. at 70° C./min, hold at 100° C. for 15 minutes, 100° C. to 170° C. at 15° C./min, hold at 170° C. for 7 min]: t_{R}=18.1 min (5d), t_{R}=20.9 min (R-6d), t_{R}=21.0 min (S-6d).

### EXAMPLE 13

### Asymmetric Transfer Hydrogenation of 4-Methoxyacetophenone Using a Ruthenium Complex of Ligand 1a Under Hydrogen

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. 4-Methoxyacetophenone (5e) (150 mg; 1.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.005 mmol; 0.005 equiv) was added, the vessel was evacuated and filled with argon five times, and the mixture was stirred for 5 min. A 1.0 M solution of potassium tert-butoxide in tert-butanol (50 uL; 0.05 mmol; 0.05 equiv) was added affording an immediate color change from pale red to orange, and the vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The vessel was sampled and analyzed by chiral GC to indicate 58.7% conversion and 90.6% ee for (S)-1-(4-methoxyphenyl)ethanol (S-6e). The reaction was stopped after 4 h by evacuating and filling with argon five times and the solution was stripped to afford 129 mg, which analyzed at 61.4% conversion, 87.8% ee S-6e.

¹H NMR (CDCl₃) δ 7.30 (m, 2H); 6.88 (m, 2H); 4.863 (q, 1H, J=6.32 Hz); 3.805 (s, 3H); 1.483 (d, 3H, J=6.32 Hz). Chiral GC [Cyclosil-B (J&W Scientific), 40° C. to 100° C. at 70° C./min, hold at 100° C. for 15 minutes, 100° C. to 170° C. at 15° C./min, hold at 170° C. for 7 min]: t_{R}=22.6 min (5e), t_{R}=22.89 min (R-6e), t_{R}=22.95 min (S-6e).

### EXAMPLE 14

### Asymmetric Transfer Hydrogenation of 4-Trifluoromethylacetophenone Using a Ruthenium Complex of Ligand 1a Under Hydrogen

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. 4-Trifluoromethylacetophenone (5f) (188 mg; 1.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.005 mmol; 0.005 equiv) was added, the vessel was evacuated and filled with argon five times, and the mixture was stirred for 5 min. A 1.0 M solution of potassium tert-butoxide in tert-butanol (50 uL; 0.05 mmol; 0.05 equiv) was added affording an immediate color change from pale red to orange, and the vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The vessel was sampled and analyzed by chiral GC to indicate 98.3% conversion and 87.2% ee for (S)-1-(4-trifluoromethylphenyl)ethanol (S-6f). The reaction was stopped after 4 h by evacuating and filling with argon five times and the solution was stripped to afford 0.19 g, which analyzed at 99.0% conversion, 87.0% ee S-6f.

¹H NMR (CDCl₃) δ 7.604 (d, 2H, J=7.70 Hz); 7.485 (d, 2H, J=7.97 Hz); 4.965 (q, 1H, J=6.05 Hz); 1.505 (d, 3H, J=6.60 Hz). Chiral GC [Cyclosil-B (J&W Scientific), 40° C. to 100° C. at 70° C./min, hold at 100° C. for 15 minutes, 100° C. to 170° C. at 15° C./min, hold at 170° C. for 7 min]: t_{R}=14.7 min (5f), t_{R}=20.0 min (R-6f), t_{R}=20.2 min (S-6f).

### EXAMPLE 15

### Asymmetric Transfer Hydrogenation of Cyclopropyl Methyl Ketone Using a Ruthenium Complex of Ligand 1a Under Hydrogen

Dichlorotris(triphenylphosphine)ruthenium(II) (14.4 mg; 0.015 mmol) and ligand 1a (7.9 mg; 0.018 mmol; 1.2 equiv based on Ru) were combined in a flask and purged with argon for 15 min. Argon-degassed isopropanol (3 mL) was added and the mixture was heated to reflux for 30 min and then cooled to ambient temperature to afford a rose-red 5.0 mM solution of the ruthenium complex of 1a. Cyclopropyl methyl ketone (5g) (99 uL; 1.0 mmol) was added to a pressure vessel, a pressure head was attached, and the vessel was evacuated and filled with argon ten times. Argon-degassed isopropanol (3.0 mL) was added and the vessel was evacuated and filled with argon five times. 1.0 mL of the solution of the ruthenium complex of 1a (0.005 mmol; 0.005 equiv) was added, the vessel was evacuated and filled with argon five times, and the mixture was stirred for 5 min. A 1.0 M solution of potassium tert-butoxide in tert-butanol (50 uL; 0.05 mmol; 0.05 equiv) was added affording an immediate color change from pale red to orange, and the vessel was evacuated and filled with argon ten times, then with hydrogen five times and pressurized to 40 psig (2.72 barg) hydrogen. The vessel was sealed and stirred vigorously for 2 h, during which time slow hydrogen uptake was noted. The vessel was sampled and analyzed by chiral GC to indicate 42.0% conversion and 79.6% ee for (S)-1-cyclopropylethanol (S-6g). After 4 h the reaction mixture analyzed at 45.3% conversion, 78.6% ee S-6g.

Chiral GC [Cyclosil-B (J&W Scientific), 55° C. isothermal]: t_{R}=6.0 min (5g), t_{R}=9.7 min (R-6g), t_{R}=9.9 min (S-6g).

### EXAMPLE 16

### Asymmetric Allylation to Afford Dimethyl 2-(1,3-diphenyl-2-propenyl)malonate(8a) Using Ligand 1a and Potassium Acetate in tert-Butyl Methyl Ether

Ligand 1a (10.9 mg; 0.025 mmol; 0.025 equiv), allylpalladium chloride dimer (3.6 mg; 0.01 mmol; 0.01 equiv), and 1,3-diphenyl-2-propenyl acetate (7a; 252 mg; 1.0 mmol) were combined in a flask along with ca. 2 mg of potassium acetate. The flask was evacuated and filled with nitrogen ten times, tert-butyl methyl ether (TBME; 5 mL) was added and the reaction mixture was stirred at ambient temperature for 15 min. Dimethyl malonate (0.34 mL; 3.0 mmol; 3 equiv) and N,O-bis(trimethylsilyl)trifluoroacetamide (0.74 mL; 3.0 mmol; 3 equiv) were then added sequentially. The reaction mixture was stirred at ambient temperature for 14 h to afford 47.4% conversion to R-8a, which had 94.4% ee according to chiral HPLC analysis.

Chiral HPLC (Chiralcel OD-H [Daicel], 250×4.6 mm, 98:2 hexane:isopropanol; 0.5 mL/min, 254 nm): t_{R}=12.4, 13.5 min (7a); t_{R}=15.8 min (R-8a), 16.8 min (S-8a).

### EXAMPLE 17

### Asymmetric Allylation to Afford Dimethyl 2-(1,3-diphenyl-2-propenyl)malonate(8a) Using Ligand 1b and Potassium Acetate in tert-Butyl Methyl Ether

Ligand 1b (14.2 mg; 0.024 mmol; 0.048 equiv), allylpalladium chloride dimer (3.6 mg; 0.01 mmol; 0.02 equiv), and 1,3-diphenyl-2-propenyl acetate (7a; 126 mg; 0.5 mmol) were combined in a flask along with ca. 2 mg of potassium acetate. The flask was evacuated and filled with nitrogen ten times, tert-butyl methyl ether (TBME; 3 mL) was added and the reaction mixture was stirred at ambient temperature for 15 min. Dimethyl malonate (171 uL; 1.5 mmol; 3 equiv) and N,O-bis(trimethylsilyl)trifluoroacetamide (467 uL; 1.5 mmol; 3 equiv) were then added sequentially. The reaction mixture was stirred at ambient temperature for 17 h to afford 99.2% conversion to S-8a, which had 84.6% ee according to chiral HPLC analysis. The reaction mixture was stripped and the residue was filtered through a pad of flash silica gel and eluted with 1:9 ethyl acetate:heptane. The fraction containing 8a was stripped under high vacuum to afford 129 mg (78%) of 8a.

¹H NMR (CDCl₃) δ 7.4-7.2 (m, 10H); 6.509 (d, 1H, J=15.95 Hz); 6.352 (dd, 1H, J=8.52, 15.67 Hz); 4.295 (dd, 1H, J=8.52, 10.72 Hz); 3.983 (d, 1H, J=11.00 Hz); 3.731 (s, 3H); 3.546 (s, 3H).

### EXAMPLE 18

### Asymmetric Allylation to Afford Dimethyl 2-(1,3-diphenyl-2-propenyl)malonate(8a) Using Ligand 1c and Potassium Acetate in tert-Butyl Methyl Ether

Ligand 1c (14.2 mg; 0.024 mmol; 0.048 equiv), allylpalladium chloride dimer (3.6 mg; 0.01 mmol; 0.02 equiv), and 1,3-diphenyl-2-propenyl acetate (7a; 126 mg; 0.5 mmol) were combined in a flask along with ca. 2 mg of potassium acetate. The flask was evacuated and filled with nitrogen ten times, tert-butyl methyl ether (TBME; 3 mL) was added and the reaction mixture was stirred at ambient temperature for 15 min. Dimethyl malonate (171 uL; 1.5 mmol; 3 equiv) and N,O-bis(trimethylsilyl)trifluoroacetamide (467 uL; 1.5 mmol; 3 equiv) were then added sequentially. The reaction mixture was stirred at ambient temperature for 3 days to afford 33.8% conversion to R-8a, which had 68.2% ee according to chiral HPLC analysis.

The invention has been described in detail with particular reference to various exemplified embodiments thereof, but it will be understood that variations and modifications will be effected within the spirit and scope of the invention.

We claim:

1. A metallocenyl PN ligand comprising the following structure: 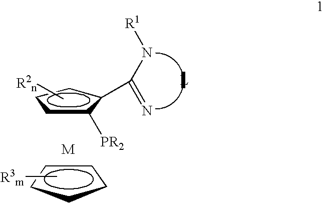
wherein
R, R²and R³ are selected from the group consisting of hydrogen, C₁-C₂₀ alkyl, C₃-C₈ cycloalkyl, C₆-C₂₀ carbocyclic aryl, and C₄-C₂₀ heteroaryl wherein the heteroatoms are sulfur, nitrogen, or oxygen;
R¹ is selected from the group consisting of hydrogen, C₂-C₂₀ alkyl, C₃-C₈ cycloalkyl, C₁-C₂₀ acyl, C₁-C₂₀ sulfonyl, C₆-C₂₀ carbocyclic aryl, and C₄-C₂₀ heteroaryl wherein the heteroatoms are sulfur, nitrogen, or oxygen;
L is a divalent radical linking the two nitrogens which optionally possesses substantially enantiomerically pure chiral centers;
n is 0 to 3;
m is 0 to 5; and
M is a metal selected from the group consisting of Group IVB, Group VB, Group VIB, Group VIIB and Group VIII.

2. The metallocenyl PN ligand according to claim 1, wherein said alkyl is substituted with one to three groups selected from the group consisting of C₁-C₆-alkoxy, cyano, C₂-C₆-alkoxycarbonyl, C₂-C₆-alkanoyloxy, hydroxy, aryl and halogen.

3. The metallocenyl PN ligand according to claim 1, wherein said aryl includes phenyl, naphthyl, or anthracenyl and phenyl, naphthyl, or anthracenyl substituted with one to three substituents selected from the group consisting of C₁-C₆-alkyl, substituted C₁-C₆-alkyl, C₆-C₁₀ aryl, substituted C₆-C₁₀ aryl, C₁-C₆-alkoxy, halogen, carboxy, cyano, C₁-C₆-alkanoyloxy, C₁l-C₆-alkylthio, C₁-C₆-alkylsulfonyl, trifluoromethyl, hydroxy, C₂-C₆-alkoxycarbonyl, C₂-C₆-alkanoylamino, —O—R⁸, S—R⁸, —SO₂—R⁸, —NHSO₂R⁸ and —NHCO₂R⁸;
wherein R⁸ is phenyl, naphthyl, or phenyl or naphthyl substituted with one to three groups selected from the group consisting of C₁-C₆-alkyl, C₆-C₁₀ aryl, C₁₋C₆-alkoxy and halogen.

4. The metallocenyl PN ligand according to claim 1, wherein said heteroaryl is a 5- or 6-membered aromatic ring containing one to three heteroatoms selected from oxygen, sulfur and nitrogen.

5. The metallocenyl PN ligand according to claim 4, wherein said heteroaryl is selected from the group consisting of thienyl, furyl, pyrrolyl, imidazolyl, pyrazolyl, thiazolyl, isothiazolyl, oxazolyl, isoxazolyl, triazolyl, thiadiazolyl, oxadiazolyl, tetrazolyl, pyridyl, pyrimidyl, benzoxazolyl, benzothiazolyl, benzimidazolyl, and indolyl.

6. The metallocenyl PN ligand according to claim 1, wherein said heteroaryl is substituted with up to three groups selected from the group consisting of C₁-C₆-alkyl, C₁-C₆-alkoxy, substituted C₁-C₆-alkyl, halogen, C₁-C₆-alkylthio, aryl, arylthio, aryloxy, C₂-C₆-alkoxycarbonyl and C₂-C₆-alkanoylamino.

7. The metallocenyl PN ligand according to claim 1, wherein said heteroaryl is substituted with a benzo or naphtho residue.

8. The metallocenyl PN ligand according to claim 1, wherein said acyl is a carboxyl radical containing up to about 20 carbon atoms.

9. The metallocenyl PN ligand according to claim 1, wherein said acyl is substituted with one to three groups selected from the group consisting of C₁-C₆-alkoxy, cyano, C₂-C₆-alkoxycarbonyl, C₂-C₆-alkanoyloxy, hydroxy, aryl and halogen.

10. The metallocenyl PN ligand according to claim 1, wherein said sulfonyl is a sulfonyl radical containing up to about 20 carbon atoms.

11. The metallocenyl PN ligand according to claim 1, wherein said sulfonyl is substituted with one to three groups selected from the group consisting of C₁-C₆-alkoxy, cyano, C₂-C₆-alkoxycarbonyl, C₂-C₆-alkanoyloxy, hydroxy, aryl and halogen.

12. The metallocenyl PN ligand according to claim 1, wherein said divalent radical L is a C₁-C₄ alkylene radical.

13. The metallocenyl PN ligand according to claim 12, wherein said divalent radical L is arranged such that L is achiral, chiral and racemic, or chiral and substantially enantiomerically pure.

14. The metallocenyl PN ligand according to claim 1, wherein said divalent radical L is selected from the group consisting of 1,2-ethanediyl, 1,3-propanediyl, 1,4-butyldiyl, S,S-1,2-dimethylethanediyl, R,R-1,2-dimethylethanediyl, S,S-1,2-diphenylethanediyl, R,R-1,2-diphenylethanediyl, R,R-1,2-diphenylethanediyl, R,R-1,2-cyclohexyldiyl, S,S-1,2-cyclohexyldiyl, and R,S-1,2-cyclohexyldiyl.

15. The metallocenyl PN ligand according to claim 1, wherein said divalent radical L forms one of an imidazoline, an imidazole, an aromatic ring, a heteroaromatic ring, a triazole, a tetrazole, a oxadiazole, and a thiadiazole.

16. A metallocenyl PN ligand comprising the following structure: 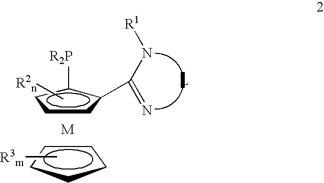
wherein
R, R²and R³ are selected from the group consisting of hydrogen, C₁-C₂₀ alkyl, C₃-C₈ cycloalkyl, C₆-C₂₀ carbocyclic aryl, and C₄-C₂₀ heteroaryl wherein the heteroatoms are sulfur, nitrogen, or oxygen;
R¹ is selected from the group consisting of hydrogen, C₂-C₂₀ alkyl, C₃-C₈ cycloalkyl, C₁-C₂₀ acyl, C₁-C₂₀ sulfonyl, C₆-C₂₀ carbocyclic aryl, and C₄-C₂₀ heteroaryl wherein the heteroatoms are sulfur, nitrogen, or oxygen;
L is a divalent radical linking the two nitrogens which optionally possesses substantially enantiomerically pure chiral centers;
n is 0 to 3;
m is 0 to 5; and
M is a metal selected from the group consisting of Group IVB, Group VB, Group VIB, Group VIIB and Group VIII.

17. The metallocenyl PN ligand according to claim 16, wherein said alkyl is substituted with one to three groups selected from the group consisting of C₁-C₆-alkoxy, cyano, C₂-C₆-alkoxycarbonyl, C₂-C₆-alkanoyloxy, hydroxy, aryl and halogen.

18. The metallocenyl PN ligand according to claim 16, wherein said aryl includes phenyl, naphthyl, or anthracenyl and phenyl, naphthyl, or anthracenyl substituted with one to three substituents selected from the group consisting of C₁-C₆-alkyl, substituted C₁-C₆-alkyl, C₆-C₁₀ aryl, substituted C₆-C₁₀ aryl, C₁-C₆-alkoxy, halogen, carboxy, cyano, C₁-C₆-alkanoyloxy, C₁-C₆-alkylthio, C₁-C₆-alkylsulfonyl, trifluoromethyl, hydroxy, C₂-C₆-alkoxycarbonyl, C₂-C₆-alkanoylamino, —O—R⁸, S—R⁸, —SO₂—R⁸, —NHSO₂R⁸ and —NHCO₂R⁸;
wherein R⁸ is phenyl, naphthyl, or phenyl or naphthyl substituted with one to three groups selected from the group consisting of C₁-C₆-alkyl, C₆-C₁₀ aryl, C₁-C₆-alkoxy and halogen.

19. The metallocenyl PN ligand according to claim 16, wherein said heteroaryl is a 5- or 6-membered aromatic ring containing one to three heteroatoms selected from oxygen, sulfur and nitrogen.

20. The metallocenyl PN ligand according to claim 19, wherein said heteroaryl is selected from the group consisting of thienyl, furyl, pyrrolyl, imidazolyl, pyrazolyl, thiazolyl, isothiazolyl, oxazolyl, isoxazolyl, triazolyl, thiadiazolyl, oxadiazolyl, tetrazolyl, pyridyl, pyrimidyl, benzoxazolyl, benzothiazolyl, benzimidazolyl, and indolyl.

21. The metallocenyl PN ligand according to claim 16, wherein said heteroaryl is substituted with up to three groups selected from the group consisting of C₁-C₆-alkyl, C₁-C₆-alkoxy, substituted C₁-C₆-alkyl, halogen, C₁-C₆-alkylthio, aryl, arylthio, aryloxy, C₂-C₆-alkoxycarbonyl and C₂-C₆-alkanoylamino.

22. The metallocenyl PN ligand according to claim 16, wherein said heteroaryl is substituted with a benzo and naphtho residue.

23. The metallocenyl PN ligand according to claim 16, wherein said acyl is a straight- or branched-chain carboxyl radical containing up to about 20 carbon atoms.

24. The metallocenyl PN ligand according to claim 16, wherein the acyl is substituted with one to three groups selected from the group consisting of C₁-C₆-alkoxy, cyano, C₂-C₆-alkoxycarbonyl, C₂-C₆-alkanoyloxy, hydroxy, aryl and halogen.

25. The metallocenyl PN ligand according to claim 16, wherein said sulfonyl is a sulfonyl radical containing up to about 20 carbon atoms.

26. The metallocenyl PN ligand according to claim 16, wherein said sulfonyl is substituted with one to three groups selected from the group consisting of C₁-C₆-alkoxy, cyano, C₂-C₆-alkoxycarbonyl, C₂-C₆-alkanoyloxy, hydroxy, aryl and halogen.

27. The metallocenyl PN ligand according to claim 16, wherein said divalent radical L is a C₁-C₄ alkylene radical.

28. The metallocenyl PN ligand according to claim 27, wherein said divalent radical L is arranged such that L is achiral, chiral and racemic, or chiral and substantially enantiomerically pure.

29. The metallocenyl PN ligand according to claim 16, wherein said divalent radical L is selected from the group consisting of 1,2-ethanediyl, 1,3-propanediyl, 1,4-butyldiyl, S,S-1,2-dimethylethanediyl, R,R-1,2-dimethylethanediyl, S,S-1,2-diphenylethanediyl, R,R-1,2-diphenylethanediyl, R,R-1,2-diphenylethanediyl, R,R-1,2-cyclohexyldiyl, S,S-1,2-cyclohexyldiyl, and R,S-1,2-cyclohexyldiyl.

30. The metallocenyl PN ligand according to claim 16, wherein said divalent radical L forms one of an imidazoline, an imidazole, an aromatic ring, a heteroaromatic ring, a triazole, a tetrazole, a oxadiazole, and a thiadiazole.

31. A process for the preparation of a metallocenyl P—N ligand having the following structure: 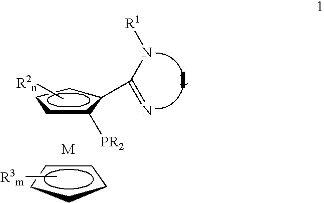
said method comprising:
reacting an oxazoline having the following structure: 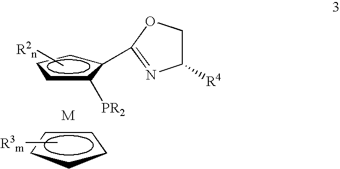
with a diamine H₂N-L-NHR¹ in an inert solvent and in the presence of an acid, wherein R⁴ is selected from the group consisting of C₁-C₂₀ alkyl, C₃-C₈ cycloalkyl, and C₆-C₂₀ carbocyclic aryl.

32. The process, according to claim 31, wherein the inert solvent is at least one of a C₁-C₁₀ alcohol or a polar aprotic solvent.

33. The process according to claim 32, wherein the solvent is 2-propanol or acetonitrile.

34. The process according to claim 31, wherein the process is carried out at a temperature between about 25° C. and the boiling point of the solvent.

35. The process according to claim 34, wherein the process is carried out at a temperature between 40-120° C.

36. The process according to claim 31, wherein the acid is a mineral acid, a sulfonic acid, or a lanthanide ion.

37. The process according to claim 36, wherein the acid is hydrochloric acid, methanesulfonic acid, or lanthanum(III) trifluoromethanesulfonate.

38. The process according to claim 31, wherein the acid is present in an amount of between 0.1 and 10 equivalents based on the oxazoline.

39. The process according to claim 31, further comprising isolating the ligand via extraction, filtration, or crystallization.

40. The process according to claim 31, further comprising purifying the ligand via extraction, chromatography, or crystallization.

41. A process for the preparation of a metallocenyl P—N ligand having the following structure: 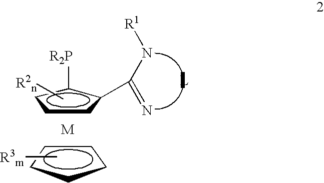
said method comprising:
reacting an oxazoline having the following structure: 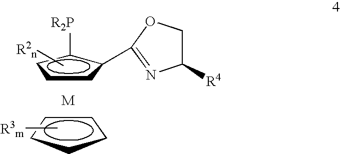
with a diamine H₂N-L-NHR¹ in an inert solvent and in the presence of an acid, wherein R⁴ is selected from the group consisting of C₁-C₂₀ alkyl, C₃-C₈ cycloalkyl, and C₆-C₂₀ carbocyclic aryl.

42. The process, according to claim 41, wherein the inert solvent is at least one of a C₁-C₁₀ alcohol or a polar aprotic solvent.

43. The process according to claim 42, wherein the solvent is 2-propanol or acetonitrile.

44. The process according to claim 41, wherein the process is carried out at a temperature between about 25° C. and the boiling point of the solvent.

45. The process according to claim 44, wherein the process is carried out at a temperature between 40-120° C.

46. The process according to claim 41, wherein the acid is a mineral acid, a sulfonic acid, or a lanthanide ion.

47. The process according to claim 46, wherein the acid is hydrochloric acid, methanesulfonic acid, or lanthanum(III) trifluoromethanesulfonate.

48. The process according to claim 41, wherein the acid is present in an amount of between 0.1 and 10 equivalents based on the oxazoline.

49. The process according to claim 41, further comprising isolating the ligand via extraction, filtration, or crystallization.

50. The process according to claim 41, further comprising purifying the ligand via extraction, chromatography, or crystallization.

51. A process for the reduction of a reducible compound, comprising:
contacting the reducible compound with a hydrogen transfer agent in the presence of a catalyst complex; and
isolating a resulting product,
wherein said catalyst complex has one of the following structures: 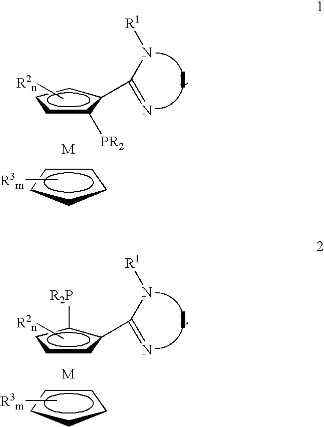
in complex association with a metal.

52. The process according to claim 51, wherein said reducible compound is a ketone having the following structure: 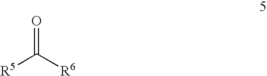
wherein R⁵, and R⁶ are independently selected from the group consisting of hydrogen, C₁ to C₂₀ alkyl, C₃ to C₈ cycloalkyl, C₆to C₂₀ carbocyclic aryl, metallocenyl, and C₄ to C₂₀ heteroaryl wherein the heteroatoms are sulfur, nitrogen, or oxygen.

53. The process according to claim 51, wherein said metal is rhodium, ruthenium, or iridium.

54. The process according to claim 51, wherein the process is under a hydrogen atmosphere at a pressure of about 0.68 to about 6.8 barg.

55. A process for producing a ligand-metal complex, comprising:
mixing a ligand and a metal pre-catalyst in a solvent and in the presence of a hydrogen donor at a temperature at which the complex will form,
wherein said ligand has one of the following structures:

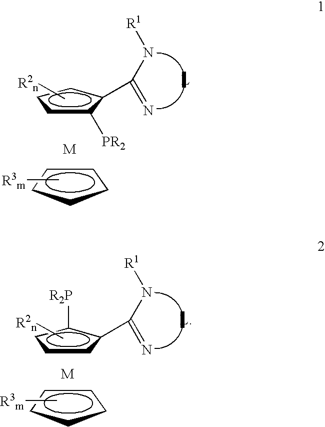

56. The process according to claim 55, wherein said metal pre-catalyst is dichlorotris(triphenylphosphine)ruthenium(II).

57. A process for the asymmetric allylation of a suitable allylic electrophile compound comprising:
contacting the allylic electrophile compound with a nucleophile in the presence of a catalyst complex; and
isolating a resulting product,
wherein said catalyst complex has one of the following structures: 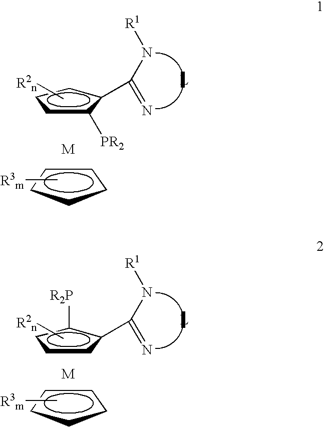
in complex association with a metal.

58. The process according to claim 57, wherein said allylic electrophile compound has the following structure: 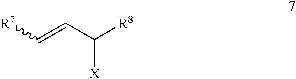
wherein R⁷ and R⁸ are independently selected from the group consisting of hydrogen, C₁ to C₂₀ alkyl, C₃ to C₈ cycloalkyl, C₆ to C₂₀ carbocyclic aryl, and C₄ to C₂₀ heteroaryl wherein the heteroatoms are sulfur, nitrogen, or oxygen; or
R⁷ and R⁸ collectively represent an alkylene group of 0-5 chain carbon atoms; and
X is selected from the group consisting of chloride, bromide, iodide, sulfonates of formula —OSO2R⁹, esters of formula —OCOR⁹, and carbonates of formula —OCOOR⁹, wherein R⁹ is selected from the group consisting of hydrogen, C₁ to C₂₀ alkyl, C₃ to C₈ cycloalkyl, C₆ to C₂₀ carbocyclic aryl, and C₄ to C₂₀ heteroaryl wherein the heteroatoms are sulfur, nitrogen, or oxygen.

59. The process according to claim 57, wherein the nucleophile is selected from the group consisting of malonates, 3-ketoesters, 2-cyanoesters, C₁-C₂₀ alcohols, phenols, and C₁-C₂₀ amines.

60. The process according to claim 57, wherein the metal is palladium, platinum, or molybdenum.
